(19) United States
(12) Patent Application Publication
(10) Pub. No.: US 2013/0251957 A1
(43) Pub. Date: Sep. 26, 2013

(54) ULTRA LOW DENSITY SYNTACTIC FOAM BUOYANCY MODULE

(71) Applicants: Lou Watkins, Stoughton, MA (US); Majdi Haddad, Peabody, MA (US)

(72) Inventors: Lou Watkins, Stoughton, MA (US); Majdi Haddad, Peabody, MA (US)

(21) Appl. No.: 13/427,527

(22) Filed: Mar. 22, 2012

(51) Int. Cl. B32B 3/20; B29C 45/14

(52) U.S. Cl. 428/188; 264/261

(57) ABSTRACT

A flotation device comprises three-dimensional cellular structure comprising a plurality of lengthwise adjacent and radially adjacent hollow cylindrical tubes, wherein interstices between the plurality of cylinders are filled with a composite matrix of macrospheres and syntactic foam.

### BACKGROUND OF THE INVENTION

The invention relates to the field of buoyancy modules, and in particular to the field of buoyancy modules that include syntactic foam.

Syntactic foam is known for use in deep-sea floats and buoys for offshore oil exploration and production. Syntactic foams are composite materials in which hollow structures, such as microspheres are dispersed in a resin matrix. A design objective involving buoyancy modules that include syntactic foam is typically to increase strength while reducing density and weight. For example, for use on an oil rig, an objective for a buoyancy module configured as a float is often to provide enough buoyancy to support the marine riser pipe while occupying as little space as possible.

There is a need for a buoyancy module that is lighter weight, less dense and smaller, and that may be used for offshore drilling.

### SUMMARY OF THE INVENTION

Briefly, according to an aspect of the present invention a flotation device with a three-dimensional cellular structure comprises a plurality of lengthwise adjacent and radially adjacent hollow cylindrical tubes, wherein interstices between the plurality of cylindrical tubes are filled with a composite matrix of macrospheres and syntactic foam.

Lengthwise ends of the hollow cylindrical tubes may be sealed so the interior of the tubes is void of macrospheres and syntactic foam. The tubes may be formed of fiber reinforced plastic composite, such as for example filament wound carbon or glass fibers with a binder such as epoxy resin.

The flotation device may also include a protective outer layer, formed for example of fiberglass. An inner surface of the flotation device may include an opening that abuts a flowline, such a length of pipe suitable for use in carrying oil.

These and other objects, features and advantages of the present invention will become apparent in light of the following detailed description of preferred embodiments thereof, as illustrated in the accompanying drawings.

### BRIEF DESCRIPTION OF THE DRAWINGS

FIG. 1 is a pictorial illustration of a syntactic foam buoyancy module;

FIG. 2 is a cut-a-way view of the buoyancy module illustrating lengthwise adjacent and radially adjacent cylindrical tubes;

FIG. 3 is a cross sectional illustration of the buoyancy module taken along line 3-3 in FIG. 2;

FIG. 4 is a perspective view of lengthwise adjacent and radially adjacent cylindrical tubes; and

FIG. 5 is a flow chart illustration of a method for manufacturing the buoyancy module.

### DETAILED DESCRIPTION OF THE INVENTION

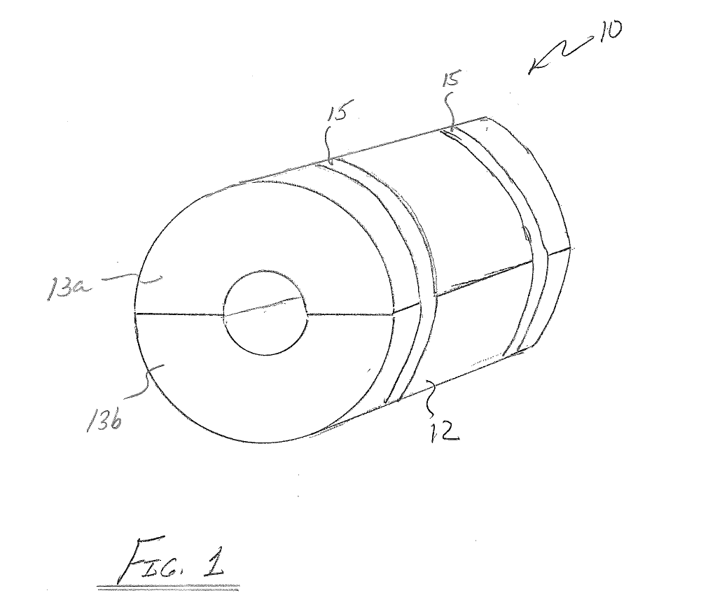

FIG. 1 is a pictorial illustration of a syntactic foam buoyancy module 10, which in this embodiment is shown as a drilling riser buoyancy module. However, one of ordinary skill in the art will recognize that buoyancy module may be used in applications other than drilling riser buoyancy modules, such as for example distributed buoyancy modules. The module 10 includes a protective exterior shell 12 (e.g., a 0.5 inch thick polymer shell) that surrounds a buoyancy core. The module 10 includes a first module 13a and a second module 13b that are mounted around a flowline (not shown), and held together around the flowline by removable clamps 15 (e.g., a synthetic fiber band such as Kelvar).

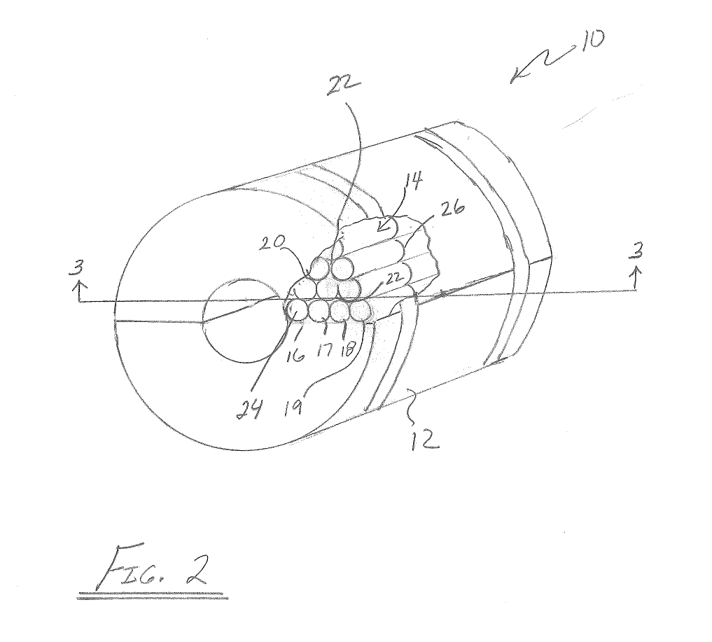

FIG. 2 is a cut-a-way view of the buoyancy module 10, with a portion of the protective exterior shell 12 cut-a-way to expose a buoyancy core 14. The core 14 comprises a plurality of lengthwise adjacent and radially adjacent cylindrical tubes, e.g., 16-20, wherein interstices between the plurality of cylindrical tubes are filled with a composite matrix 22 of macrospheres and syntactic foam. Lengthwise ends 24, 26 of each of the plurality of cylindrical tubes may be sealed so the interior of the tubes is void of the composite matrix 22, and thus hollow.

In one embodiment, each of the cylindrical tubes 16-20 may be about 12 inches long and have a diameter of about 4 inches. The shorter the length of the tubes, the better for fault tolerance in the event one of the tubes cracks/fractures as a result of hydrostatic pressure cracking/fracturing the cylinder. Conversely, the longer the cylinder the easier for manufacture, which shall be discussed below. Thus the cylinder length and diameter are a trade-off depending upon the application of the buoyancy module. The cylindrical tubes sidewalls may have a wall thickness of about 0.0625 inches and be constructed of filament wound carbon or glass fibers with an epoxy resin binder. In an alternative embodiment, cylindrical tubes sidewalls may be constructed of thermoplastic.

As an example of an advantages offered by the invention, conventional riser buoyancy modules may have a density of about 25.0 to 28.0 pcf (lbs per cubic foot) when rated for a service depth of 5,000 feet. Modules of the tubular construction will have a density of about 20.0 to 22.0 pcf, affording a significant reduction in the weight of the drilling system.

Although the cross section of the tubes is preferably cylindrical, it is contemplated that other cross sectional shapes may also be used for the tubes. For example, it is contemplated that the tubes may have an octagonal cross-section. In general, the tube may be any rigid, lightweight, elongated hollow body, which also includes for example rectangular or hexagonal.

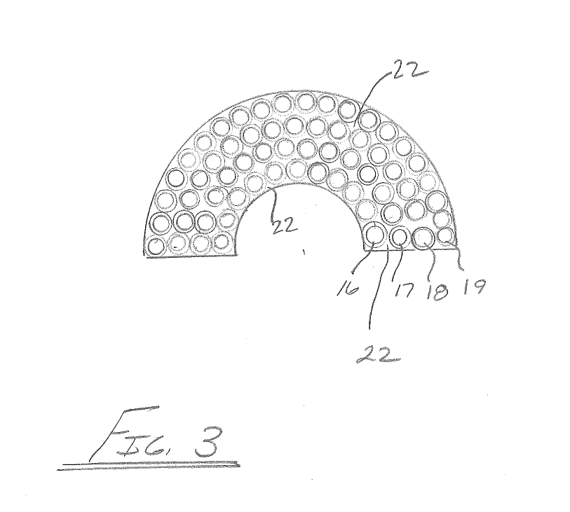

FIG. 3 is a cross sectional illustration of the buoyancy module taken along line 3-3 in FIG. 2. Interstices between the tubes 16-20 are filled with the composite matrix 22 of macrospheres and syntactic foam, which contains microspheres and a resin binder (e.g., a semi-rigid resin binder such as epoxy, polyester, or polyurethane).

The macrospheres are generally spherical shaped and have a diameter of about 0.25 to 0.5 inches. The walls are preferably fiberglass or carbon composite and have thickness dependent upon the intended operational depth. Specifically, the greater the intended operational depth of the buoyancy module, the greater the wall thickness required to sustain the hydrostatic pressure at that depth. For example, at depths where the hydrostatic pressure is a thousand psi or less, the wall thickness may be quite thin (e.g., 0.01 inches). In contrast, at ten thousand feet where the hydrostatic pressure approaches 5,000 psi the wall thickness is increased significantly (e.g., 0.03 inches). It is contemplated that other high strength advanced composite type fibers (e.g., other carbon fibers, aramid, etc.) may also be used rather than fiberglass.

The microspheres interspersed within the resin binder are typically about 100 microns in diameter (i.e., 0.004″) hollow spheres generally containing a gas which may be atmospheric air, although it may be richer in nitrogen than atmospheric air. The microspheres may have a wall thickness of about one micron. As known, the microspheres are manufactured by blowing glass in a furnace in the presence of blowing agents that cause the glass to bubble.

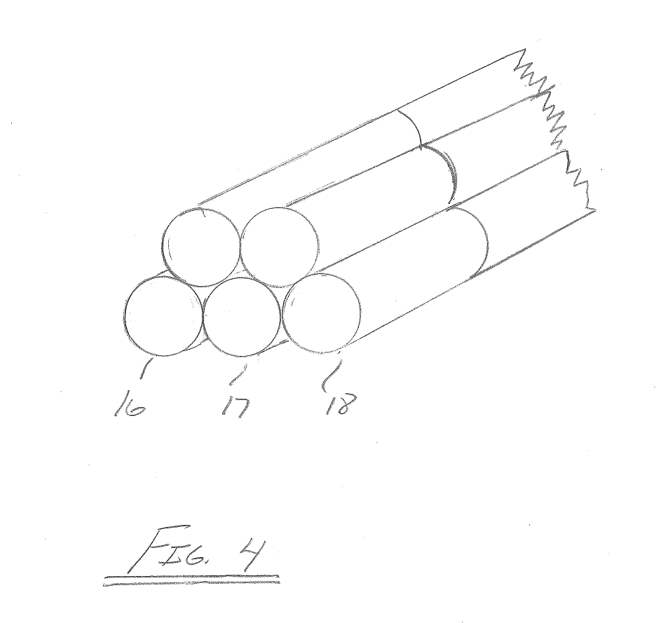

FIG. 4 is a perspective view of the lengthwise adjacent and radially adjacent cylindrical tubes 16-20.

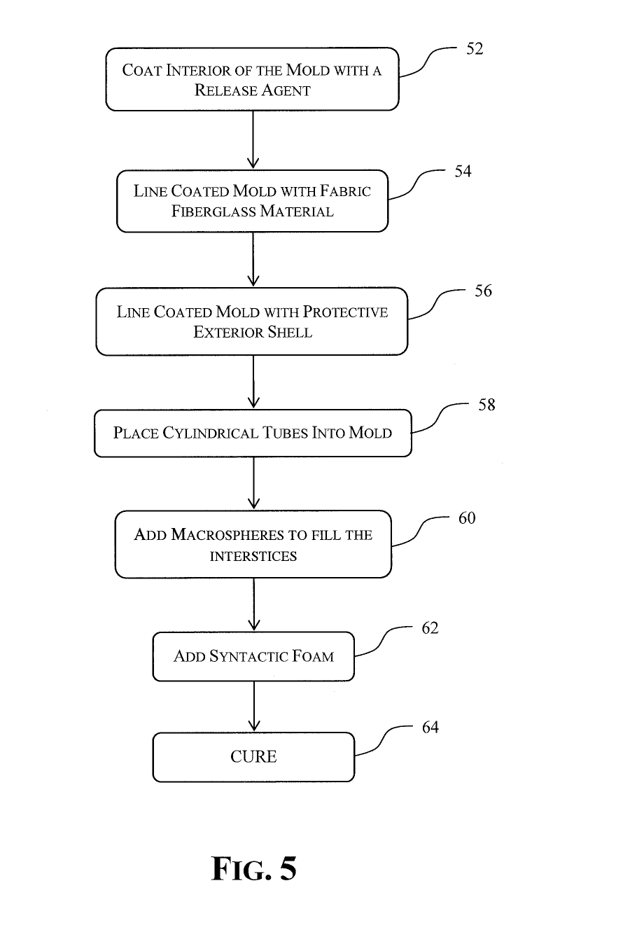

FIG. 5 is a flow chart illustration of a method for manufacturing the buoyancy module. The method of manufacturing includes step 52 in which a mold that provides a cavity the shape of which provides a positive shape of the object to be molded, is coated with a release agent. In step 54 the coated mold is then lined with a fabric fiberglass material 56. The mold is then lined with the protective exterior shell 12 in step 6. The fiberglass material and the liner are put in dry. In step 58 the tubes are then placed into the mold such that they are lengthwise adjacent and radially adjacent, and fill the mold. The macrospheres are then introduced in step 60 into the mold and vibrated to fill interstices between the tubes. In step 62 syntactic foam is injected under vacuum to fill in space between the macrospheres and tubes. The mold is then placed in an oven to cure in step 64.

In an alternative embodiment the tubes may be of different lengths, diameters and wall thickness. For example, it is contemplated that the tubes located at the peripheral surfaces of the buoyancy module may have a thicker wall surface, be of a shorter length, et cetera, in comparison to tubes located within interior regions of the buoyancy module.

The buoyancy module may be used for riser modules, fairings, riser drag reduction devices, distributed buoyancy, ROV floats, et cetera.

Although the present invention has been shown and described with respect to several preferred embodiments thereof, various changes, omissions and additions to the form and detail thereof, may be made therein, without departing from the spirit and scope of the invention.

What is claimed is:

1. A flotation device, comprising:
three-dimensional cellular structure comprising a plurality of lengthwise adjacent and radially adjacent hollow cylindrical tubes, wherein interstices between the plurality of cylinders are filled with a composite matrix of macrospheres and syntactic foam.

2. The flotation device of claim 1, where the cylindrical tubes comprise filament wound carbon fibers.

3. The flotation device of claim 1, where the cylindrical tubes comprise filament wound carbon or glass fibers with an epoxy resin binder.

4. The flotation device of claim 1, where the cylindrical tubes are made of a wide variety of other materials.

5. The flotation device of claim 3, where the syntactic foam comprises microspheres and a polymeric binder.

6. The flotation device of claim 1, where the cylindrical tubes comprise thermoplastic.

7. A method of manufacturing a flotation device, comprising:
coating a mold with a release agent;
lining the coated mold with a liner;
placing a plurality of lengthwise adjacent and radially adjacent tubes into the coated mold to substantially fill the mold;
introducing macrospheres into the mold to fill interstices between the tubes;
injected syntactic foam into the mold to fill in spaces between the macrospheres and the tubes; and
placing the filled mold into an oven to be cured.
